(19) United States
(12) Patent Application Publication
(10) Pub. No.: US 2016/0307090 A1
(43) Pub. Date: Oct. 20, 2016

(54) AUXILIARY MOUNTING STRUCTURE FOR MOUNTING ADVANCED SMART CARD

(71) Applicant: Taisys Technologies Co., Ltd., Taipei (TW)

(72) Inventors: Chun-Hsin HO, Taipei (TW); Tung-Hai LEE, Taipei (TW)

(73) Assignee: Taisys Technologies Co., Ltd., Taipei (TW)

(21) Appl. No.: 14/838,759

(22) Filed: Aug. 28, 2015

(30) Foreign Application Priority Data
Apr. 17, 2015 (TW) 104112432

(51) Int. Cl. G06K 19/077; H04M 1/02

(52) U.S. Cl. CPC G06K 19/07743; H04M 1/026

(57) ABSTRACT

An auxiliary mounting structure, for mounting an advanced smart card which has a contact side with a number of smart card contacts, onto a Subscriber Identity Module (SIM) card is disclosed. The auxiliary mounting structure is formed by a board and has several key parts. With the help of the auxiliary mounting structure, the advanced smart card can be easily attached to the SIM card without aligning contacts.

### FIELD OF THE INVENTION

The present invention relates to an auxiliary mounting structure. More particularly, the present invention relates to an auxiliary mounting structure for mounting an advanced smart card.

### BACKGROUND OF THE INVENTION

Generally, there are many types of telecommunication networks, which have been established for providing a variety of services to network subscribers. Certainly, the widely used and well-known service provided by telecommunication networks is mobile phone services, such as with cellular telephones. Meanwhile, several surface contacting cards with special circuits are widely used in electronic devices to enhance the functions of the electronic devices for providing more services. For example, a subscriber identity module (SIM) card could be placed into a portable phone to dedicate the phone's functions to the SIM card owner. Furthermore, some telecommunication networks provide other services that involve banking operations and transaction functions. However, the compact SIM card merely includes basic information of owner for providing a variety of services to network subscribers. When services of banking operations and transaction functions are provided, there should be a lot of data transmission between telecommunication networks because the compact SIM in the portable phone could not provide further information.

Moreover, IC cards are used in numerous applications such as payment at a point of sale (known as “bank cards”), public telephones, payment for parking, payment for tolls, mobile telephones (e.g., SIM cards), public transportation, or electronic purse. Each of these applications is associated with a specific card: a bank card, a phone card, a parking card, a SIM card for GSM telephony, and so on.

In practice, the problems ensuing from stolen and forged credit cards and cash cards are becoming more and more serious, and increased efforts are made to reduce the risks involved in this respect. Many solutions have been proposed, including time limits, limited withdrawals, duplicate encryption, and the identification of the card owner with all manner of means ranging from PIN codes to fingerprints, one-time passwords, etc. Regardless of the solutions applied, a fraudulent person is able to pass through the different barriers and obstacles with the aid of ever more sophisticated methods.

Furthermore, the use of mobile telephones or electronic wallets has also been a means of payment, and an increasing number of payments in greater sums will at times be made in electronic cash. False/cloned telephones and SIM cards already exist, and the use of telephones and SIM cards in respect of payments will increase the above-identified risks still more.

One of the problems encountered in daily use of such a variety of smart cards lies in that one of the cards might not be available when it is to be used, no matter whether it is left at home, its credit has been run out, or it has expired. In addition, administration and carry of various smart cards is inconvenient. Therefore, there is a strong need for the so-called “multi-application cards”.

Nowadays, a trend is obvious is that functions of the smart cards may be integrated into one SIM card or worked via an intermedia device. For the latter, a contactless transaction adaptor disclosed in U.S. Pat. No. 8,424,757 is an example. Such kind of devices usually is in form of a laminated smart card interface and has two sides of contacts. One side is for connecting with a SIM card while the other side linked to the SIM card slot. Therefore, when a mobile phone is communicating with the SIM card, additional functions can be provided by the device through the SIM card slot along with the message from the SIM card. However, the contacts of the SIM card and the device are tiny and arranged closely. It is not easy for users to install the SIM card onto the device with corresponding contacts matched. This mismatch of contacts will lead circuit short, further causing the SIM card non-working. Hence, an auxiliary mounting structure used for mounting the smart card on to the SIM card easily is desired.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In order to settle the problems mentioned above, an auxiliary mounting structure, for mounting an advanced smart card which has a contact side with a number of smart card contacts, onto a Subscriber Identity Module (SIM) card, formed by a board which has a shape approximate to a rectangle is disclosed. The auxiliary mounting structure includes: a first accommodating portion, including: a first removed region, having a shape substantially equal to that of a first type SIM card; and a second removed region, formed below the first removed region and penetrating the board, having a shape substantially equal to that of a second type SIM card; a second accommodating portion, including: a third removed region, having a shape substantially equal to that of the second type SIM card; and a fourth removed region, formed below the third removed region and penetrating the board, having a shape substantially equal to that of a third type SIM card; a folding line, formed between the first accommodating portion and the second accommodating portion, for dividing the auxiliary mounting structure into equal sizes and facilitating folding of the auxiliary mounting structure; and a plastic film, glued on a gluing side, attached underneath the first removed region. A shape of the advanced smart card is substantially the same as that of the second type SIM card. Locations and shapes of the second removed region are mirroring of that of the third removed region with respect to the folding line.

Preferably, the board is made of cardboard, plastic, carbon fiber, or metal. The first type SIM card is a mini-SIM card (2FF). The second type SIM card is a micro-SIM card (3FF). The third type SIM card is a nano-SIM card (4FF). The plastic film is made by Poly Ethylene (PE), Poly Vinyl Chloride (PVC) or Poly Ethylene Terephthalate (PET). The advanced smart card has a flexible printed circuit board with the smart card contacts on the contact side and an integrated circuit. The advanced smart card has a layer of glue around the smart card contacts and covered by a release paper.

With the help of the auxiliary mounting structure, the advanced smart card can be easily attached to the SIM card without aligning contacts.

### BRIEF DESCRIPTION OF THE DRAWINGS

FIG. 1 shows a top view of an auxiliary mounting structure according to the present invention.

FIG. 2 shows a bottom view of the auxiliary mounting structure.

FIG. 3 is a top view of an advanced smart card.

FIG. 4 is a bottom view of an advanced smart card.

FIG. 5 illustrates mounting the advanced smart card onto a nano-SIM card.

FIG. 6 illustrates mounting the advanced smart card onto a micro-SIM card.

FIG. 7 illustrates mounting the advanced smart card onto a mini-SIM card.

FIG. 8 shows a top view of another auxiliary mounting structure according to the present invention.

FIG. 9 shows that the auxiliary mounting structure is mounted onto the advanced smart card.

FIG. 10 shows a bottom view of the auxiliary mounting structure.

FIG. 11 illustrates mounting the advanced smart card onto a mini-SIM card.

FIG. 12 illustrates mounting the advanced smart card onto a micro-SIM card.

FIG. 13 illustrates mounting the advanced smart card onto a nano-SIM card.

FIG. 14 illustrates mounting the advanced smart card onto a nano-SIM card.

### DETAILED DESCRIPTION OF THE PREFERRED EMBODIMENTS

The present invention will now be described more specifically with reference to the following embodiments.

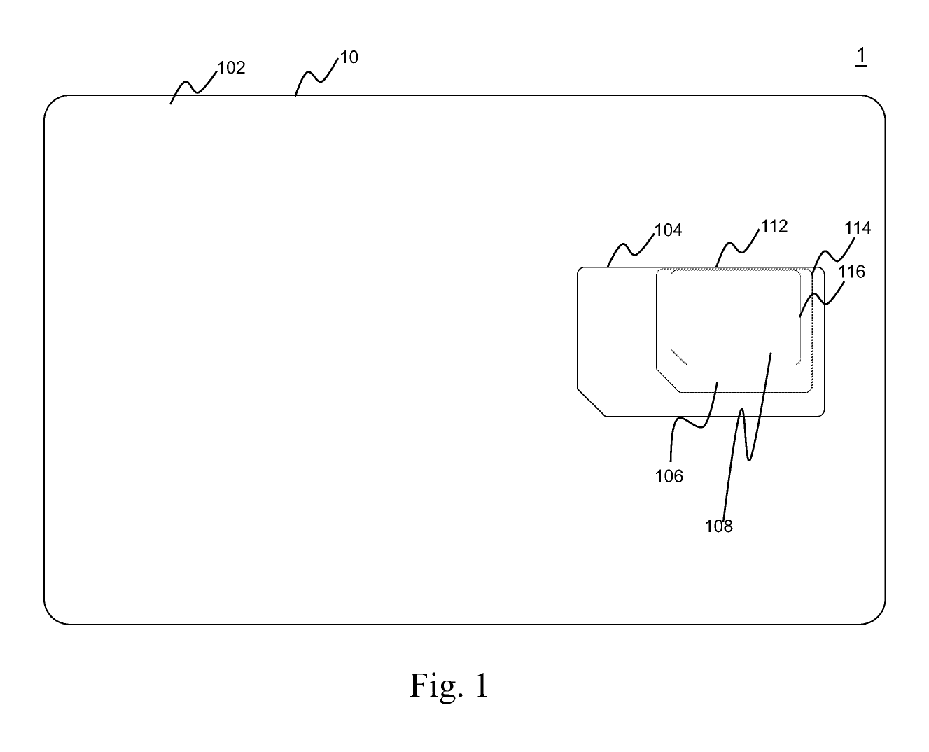

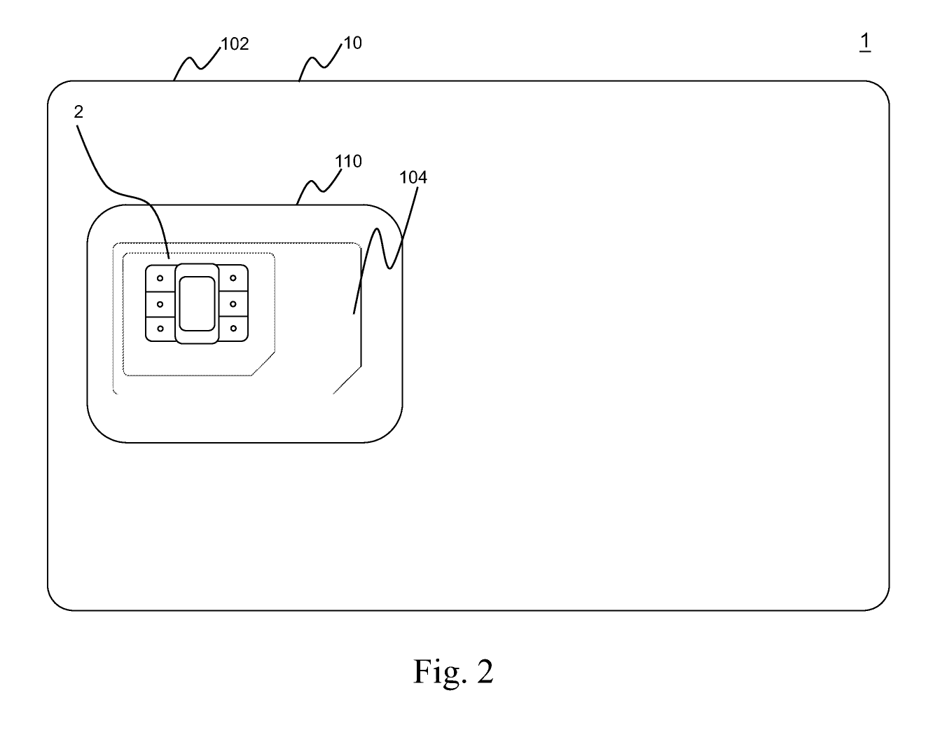

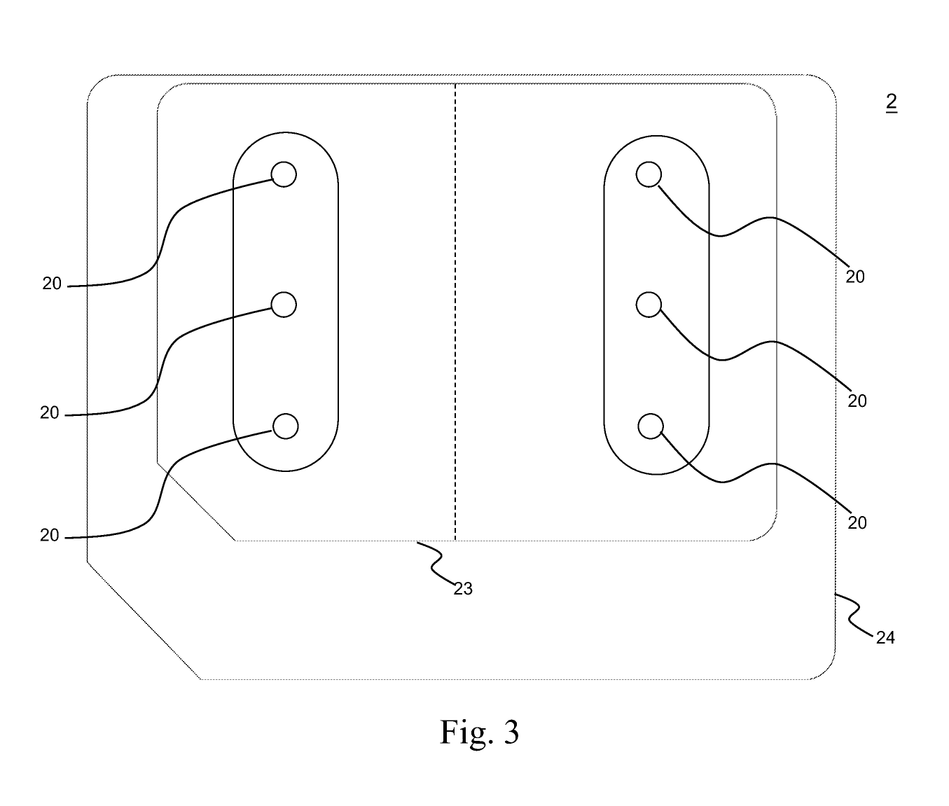

Please see FIG. 1 to FIG. 7. An embodiment of the present invention is disclosed. FIG. 1 shows a top view of an auxiliary mounting structure 1. FIG. 2 is a bottom view of the auxiliary mounting structure 1. The auxiliary mounting structure 1 is used for mounting an advanced smart card 2 (Please see FIG. 3) onto a Subscriber Identity Module (SIM). The advanced smart card 2 has a contact side (as depicted by FIG. 3) with a number of smart card contacts 20. Each smart card contact 20 connects to a corresponding SIM card contact. The auxiliary mounting structure 1 is formed by a board 10. The board 10 has a shape approximate to a rectangle. In this embodiment, the board 10 is the same as the shape of a full-size SIM card (1FF).

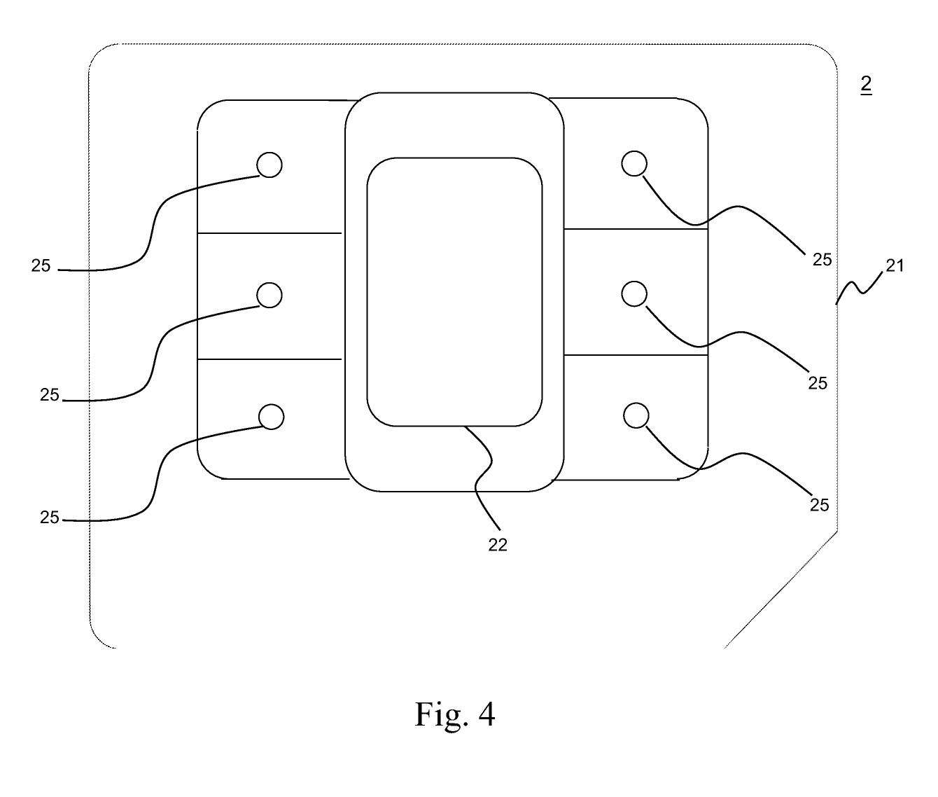

Before introducing the details of the auxiliary mounting structure 1, the advanced smart card 2 should be described first. The advanced smart card 2 basically includes a flexible printed circuit board 21 with the smart card contacts 20 on the contact side and an integrated circuit 22 mounted on the other side (as depicted by FIG. 4. In practice, it can be on the same side with the smart card contacts 20). It has a layer of glue (not shown) around the smart card contacts 22 and covered by a release paper. Preferably, the release paper is separated into two portions, an inner portion 23 and an outer portion 24. Use of the release paper will be illustrated later. There are also several contacts 25 of the SIM card on the other side. The contacts 25 are used to be connected to a SIM card slot so that the SIM card and the integrated circuit 22 can communicate with a smart phone through the contacts 25.

The board auxiliary mounting structure 1 has five key elements: a first cut-out body 102, a second cut-out body 104, a third cut-out body 106, a fourth cut-out body 108, and a plastic film 110. The auxiliary mounting structure 1 is formed by cutting the board 10. The first cut-out body 102 has a shape approximate a rectangle. In the present embodiment, the shape of the first cut-out body 102 is the same as a full-size subscriber identity module card (1FF). In fact, the first cut-out body 102 can be in any shape. Each element is illustrated below.

A first cut-out portion 112 is formed in the first cut-out body 102. The first cut-out portion 112 has a shape of the first type SIM card. Namely, the first cut-out portion 112 can accommodate a mini-SIM card with the contacts facing away from the reader. Hereinafter, the first type SIM card refers to the mini-SIM (2FF). As mentioned above, the first cut-out portion 112 is formed by a board 10. Materials cut out from the first cut-out portion 112 can be used to form the second cut-out body 104, the third cut-out body 106 and the fourth cut-out body 108.

The second cut-out body 104 forms a shape of the first type SIM card. It is accommodated in the first cut-out portion 112 before the auxiliary mounting structure 1 is ready for use. The second cut-out body 104 has a second cut-out portion 114. The second cut-out portion 114 has a shape of the second type SIM card. Similarly, the second cut-out body 104 utilizes the materials cut out from the first cut-out portion 112 and is formed by the board 10. Materials cut out from the second cut-out portion 114 can be further used to from the third cut-out body 106 and the fourth cut-out body 108. The second cut-out portion 114 can accommodate a micro-SIM card with the contacts facing away from the reader. Hereinafter, the second type SIM card refers to the micro-SIM (3FF).

The third cut-out body 106 forms a shape of the second type SIM card. It is accommodated in the second cut-out portion 114 before the auxiliary mounting structure 1 is ready for use. The third cut-out body 106 has a third cut-out portion 116. The third cut-out portion 116 has a shape of a third type SIM card. Materials removed from the third cut-out portion 116 can form the fourth cut-out body 108. The third cut-out portion 116 can accommodate a nano-SIM with the contacts facing away from the reader. Hereinafter, the third type SIM card refers to the nano-SIM (4FF).

The plastic film 110 has been glued on a gluing side. It is attached to a portion of the first cut-out body 102, the second cut-out body 104 and the advanced smart card 2. The glue should not be too strong. Thus, the second cut-out body 104 can be taken away from the plastic film 110. The attached object will not be damaged by the stickiness of the glue. In the present embodiment, the plastic film 110 is made of Poly Ethylene (PE). In fact, it can be made by Poly Vinyl Chloride (PVC) or Poly Ethylene Terephthalate (PET).

A shape of the advanced smart card 2 is substantially the same as that of the second cut-out body 104. The advanced smart card 2 is located under the third cut-out body 106 and the fourth cut-out body 108. When the second cut-out body 104, the third cut-out body 106 and the fourth cut-out body 108 are removed and the first type SIM card is placed into the first cut-out portion 112, smart card contacts 20 contact corresponding contacts of the first type SIM card. When the third cut-out body 106 and the fourth cut-out body 108 are removed and the second type SIM card is placed into the second cut-out portion 114, smart card contacts 20 contact corresponding contacts of the second type SIM card. When the fourth cut-out body 108 is removed and the third type SIM card is placed into the third cut-out portion 116, smart card contacts 20 contact corresponding contacts of the third type SIM card. Because corresponding contacts of the three SIM cards have the same location, smart card contacts 20 can contact the corresponding contacts of every SIM cards by adjusting the second cut-out body 104, the third cut-out body 106 and the fourth cut-out body 108.

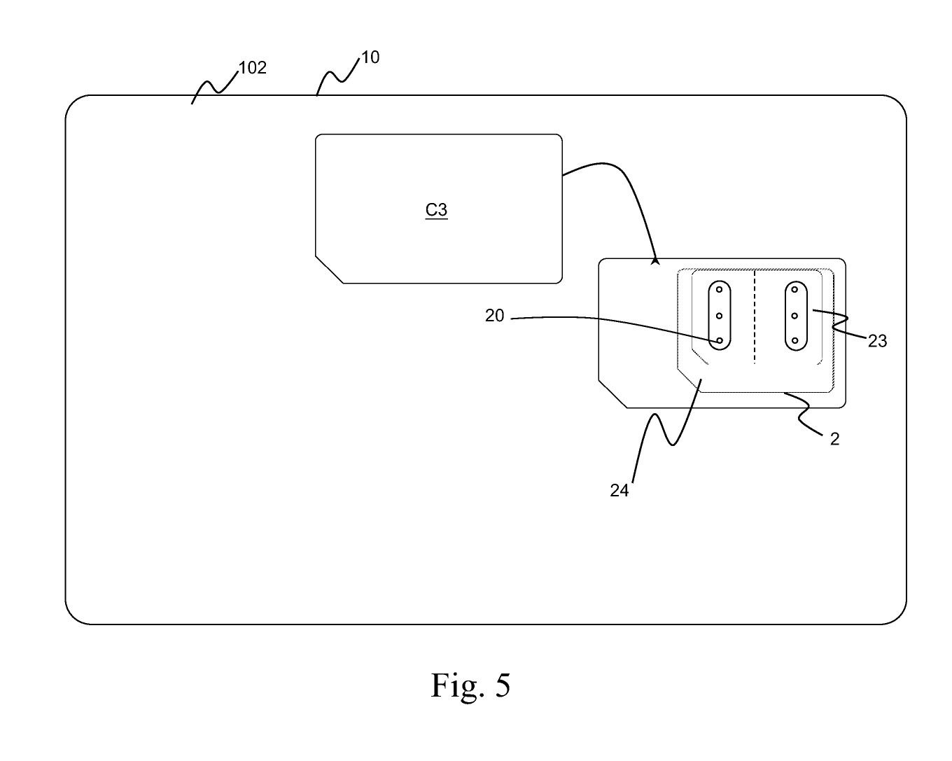

For using different type of SIM card, a different procedure is applied. Please refer to FIG. 5. It should be noticed that in order to have a better understanding of these examples, the drawings mentioned below show another side of the auxiliary mounting structure 1, different from FIG. 2. If the auxiliary mounting structure 1 is used to mount the advanced smart card 2 onto a mini-SIM card C3, the whole procedure is illustrated as below. First, the second cut-out body 104, the third cut-out body 106 and the fourth cut-out body 108 should be removed. The first cut-out body 102 and the advanced smart card 2 stay are stuck by the plastic film 110 which is on the back side of the first cut-out body 102. Next, remove the inner portion 23 and outer portion 24 of the release paper. Then, put the mini-SIM card C3 into the first cut-out portion 112 with the contacts of the mini-SIM card C3 facing the first cut-out body 102. Finally, remove the advanced smart card 2 from the plastic film 110. Because the advanced smart card 2 contacts the glue, the advanced smart card 2 is mounted onto the mini-SIM card C3.

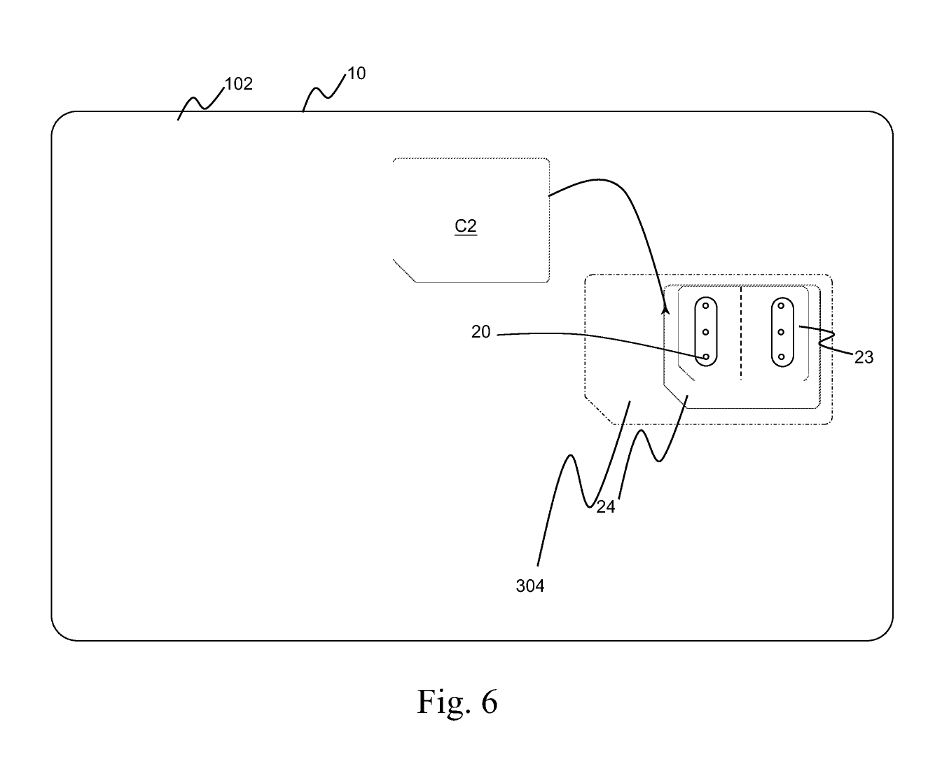

Please see FIG. 6. If the auxiliary mounting structure 1 is used to mount the advanced smart card 2 onto the micro-SIM card C2, the third cut-out body 106 and the fourth cut-out body 108 should be removed in the first step. The dashed-lined frame indicates the second cut-out body 104 is still integrated in the first cut-out body 102. The first cut-out body 102, the second cut-out body 104 and the advanced smart card 2 are stuck by the plastic film 110. Next, remove the inner portion 23 and outer portion 24 of the release paper. Then, put the micro-SIM card C2 into the second cut-out portion 114 with the contacts of the micro-SIM card C2 facing the first cut-out body 102. Finally, remove the advanced smart card 2 from the plastic film 110. The advanced smart card 2 is mounted onto the micro-SIM card C2.

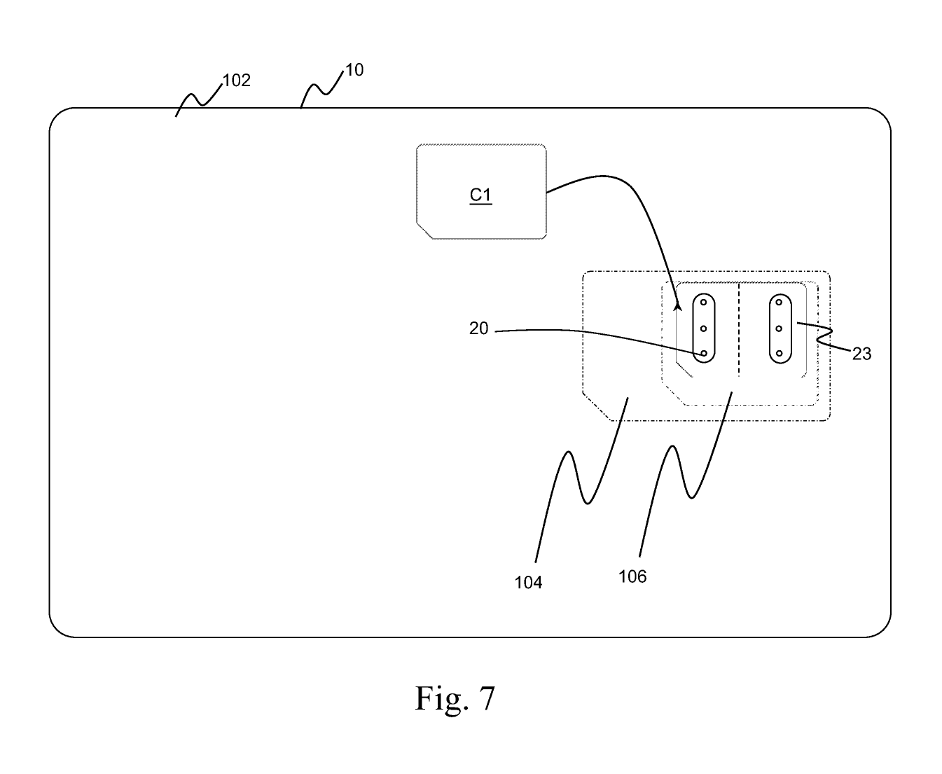

If the auxiliary mounting structure 1 is used to mount the advanced smart card 2 onto a nano-SIM card C1, the fourth cut-out body 108 should be removed in the first step. Please see FIG. 7. Two dashed-lined frames indicate the second cut-out body 104 and the third cut-out body 106 are still integrated in the first cut-out body 102. Next, remove the inner portion 23 of the release paper. Then, put the nano-SIM card C1 into the third cut-out portion 116 with the contacts of the nano-SIM card C1 facing the first cut-out body 102. Finally, remove the advanced smart card 2 from the plastic film 110. The advanced smart card 2 is thus mounted onto the nano-SIM card C1.

According to the spirit of the present invention, there is a second form of auxiliary mounting structure. It is illustrated in another embodiment below.

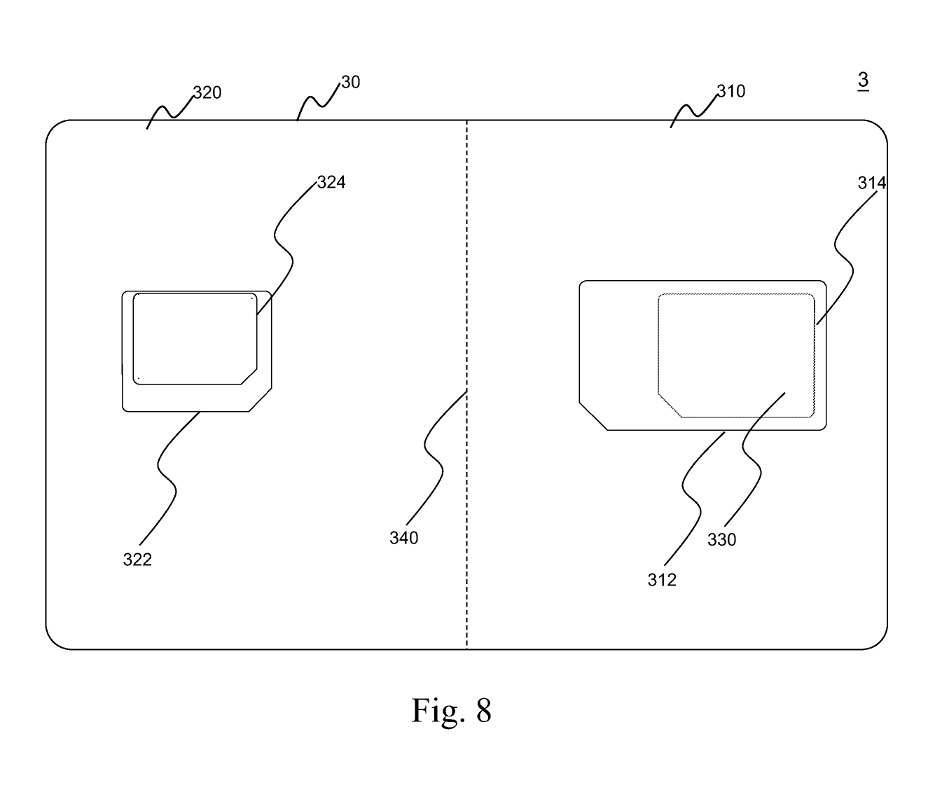

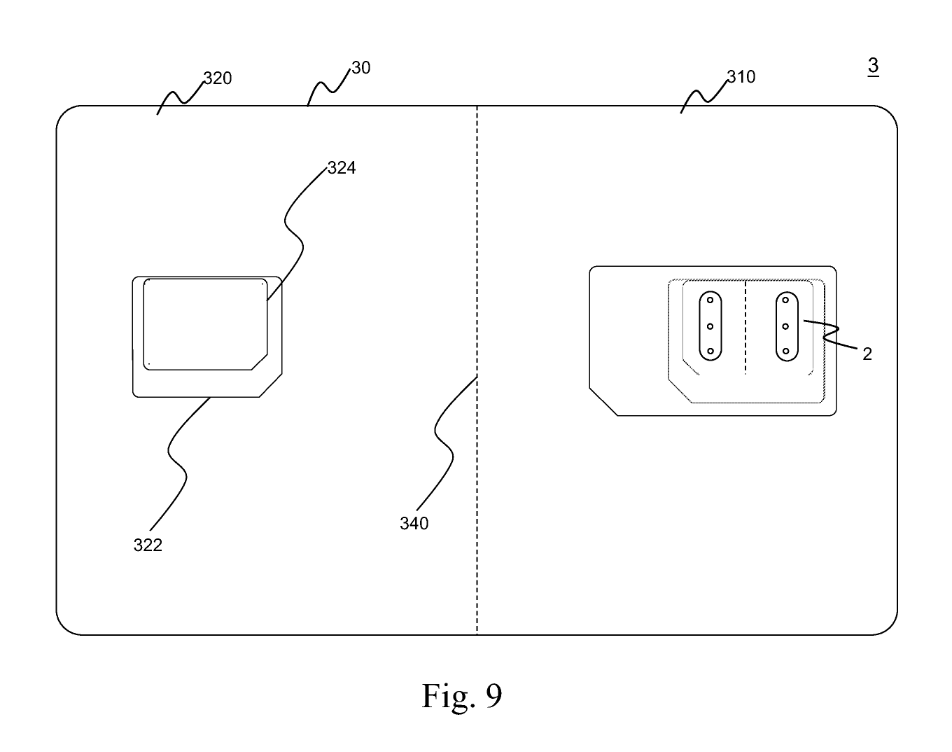

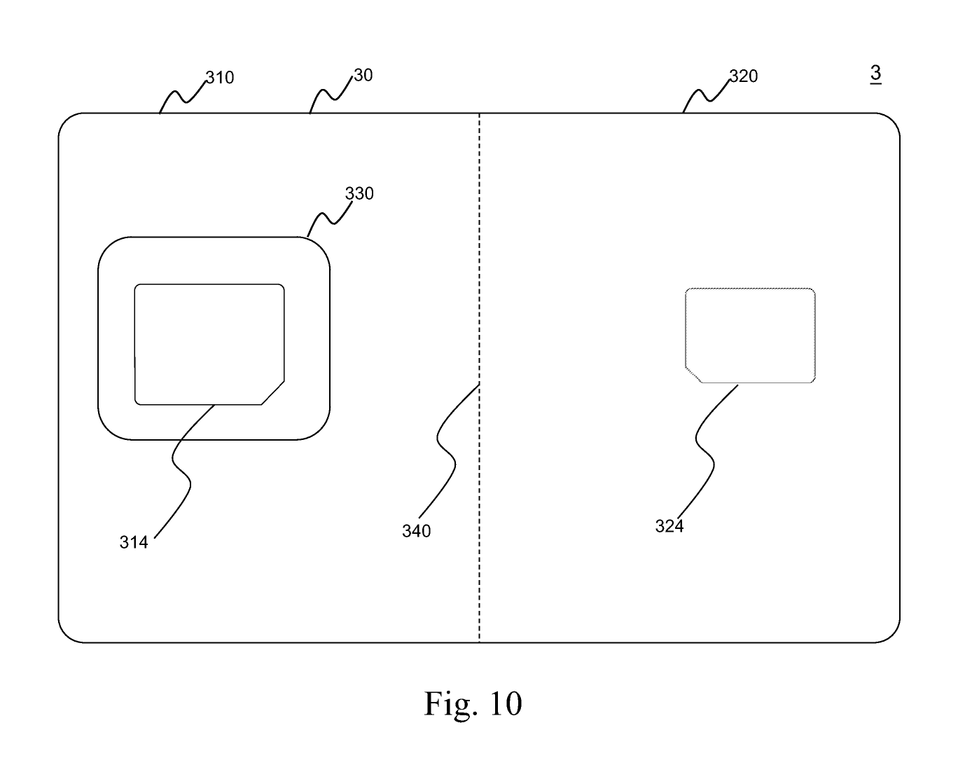

Please see FIG. 8 to FIG. 14. An embodiment of the present invention is disclosed. FIG. 8 shows a top view of an auxiliary mounting structure 3. FIG. 9 shows another top view of the auxiliary mounting structure 3 mounted with the advanced smart card 2. FIG. 10 depicts a bottom view of the auxiliary mounting structure 3 where a plastic film 330 is sketched. The auxiliary mounting structure 3 is used to mount the advanced smart card 2 onto a SIM. Structure and functions of the advanced smart card 2 are the same as that in the previous embodiment. It is not repeated again.

The auxiliary mounting structure 3 has four key elements. They are a first accommodating portion 310, a second accommodating portion 320, a folding line 340 and the plastic film 330. The auxiliary mounting structure 3 is formed by cutting a board 30. The auxiliary mounting structure 3 has a shape close to a rectangle. In this embodiment, the shape of the auxiliary mounting structure 3 is the same as the full-size SIM card (1FF). In fact, the auxiliary mounting structure 3 can have any shape. All elements are illustrated below.

The first accommodating portion 310 has a first removed region 312 and a second removed region 314 inside. The first removed region 312 has a shape substantially the same as that of the first type SIM card. It is to say that the first removed region 312 can accommodate a mini-SIM card with contacts facing away from the reader. In addition, the first removed region 312 does not penetrate the board forming the auxiliary mounting structure 3. Thickness of the first removed region 312 in the auxiliary mounting structure 3 is thick enough to fix the mini-SIM card. The second removed region 314 is formed below the first removed region 312 and penetrates the board, having a shape substantially the same as that of the second type SIM card. Therefore, the second removed region 314 can accommodate the micro-SIM card or the advanced smart card 2. The contacts of the micro-SIM card faces away from the reader. The advanced smart card 2 is show in FIG. 9.

The second accommodating portion 320 has a third removed region 322 and a fourth removed region 324 inside. The third removed region 322 has a shape substantially the same as that of the second type SIM card. It is to say that the third removed region 322 can accommodate a micro-SIM card with the contacts facing the reader. The third removed region 322 does not penetrate the board forming the auxiliary mounting structure 3. Thickness of the third removed region 322 in the auxiliary mounting structure 3 is thick enough to fix the mini-SIM card. The fourth removed region 324 is formed below the third removed region 322 and penetrates the board, having a shape substantially the same as that of the third type SIM card. Therefore, the fourth removed region 324 can accommodate the nano-SIM card. The contacts of the nano-SIM card faces away from the reader.

The folding line 340 is formed between the first accommodating portion 310 and the second accommodating portion 320. It is used to divide the auxiliary mounting structure 3 into equal sizes (the present embodiment) or different sizes, and facilitate folding of the auxiliary mounting structure 3.

The plastic film 330 has been glued on a gluing side, attached underneath the first removed region 312. A specific location is shown in FIG. 10. The plastic film 330 can temporarily stick the object (i.e., the advanced smart card 2) in the second removed region 314. The glue should not be too strong. Thus, the advanced smart card 2 will not be damaged by the stickiness of the glue. It can be taken away from the plastic film 330. As the previous embodiment, the plastic film 330 is made of PE. In fact, it can be made by PVC or PET.

The shape of the advanced smart card 2 is substantially the same as that of the second type SIM card. When using, the advanced smart card 2 is placed into the second removed region 314, temporarily fixed by the plastic film 330. However, for selling the auxiliary mounting structure 3 and the advanced smart card 2 together, it can be taken into consideration that the platform formed by the board of the auxiliary mounting structure 3, between the third removed region 322 but not and the fourth removed region 324, can be glued to stick the outer portion 24 of the release paper of the advanced smart card 2. In addition, it can also glue one side of a small board (not shown), which is shaped as the third type SIM card. Put the small board into the fourth removed region 324. By combining with the inner portion 23 of the release paper of the advanced smart card 2, the advanced smart card 2 can be further fixed. Meanwhile, another separating release paper (not shown) which is shaped as the second type SIM card is attached to the plastic film 330 in the second removed region 314. The small board can be formed together with the auxiliary mounting structure 3 for the advanced smart card 2. The small board has a thickness the same as that of the fourth removed region 324. It is formed by stamping.

Locations and shapes of the second removed region 314 are mirroring of that of the third removed region 322 with respect to the folding line 340. If the second type SIM card is placed into the third removed region 322, the advanced smart card 2 is placed into the second removed region 314, and the auxiliary mounting structure 3 is folded along the folding line 340, contacts of the advanced smart card 2 can contact the corresponding contacts on the second type SIM card. Besides, if the third type SIM card is placed into the fourth removed region 324, the advanced smart card 2 is placed into the second removed region 314, and the auxiliary mounting structure 3 is folded along the folding line 340, contacts of the advanced smart card 2 can contact the corresponding contacts on the third type SIM card.

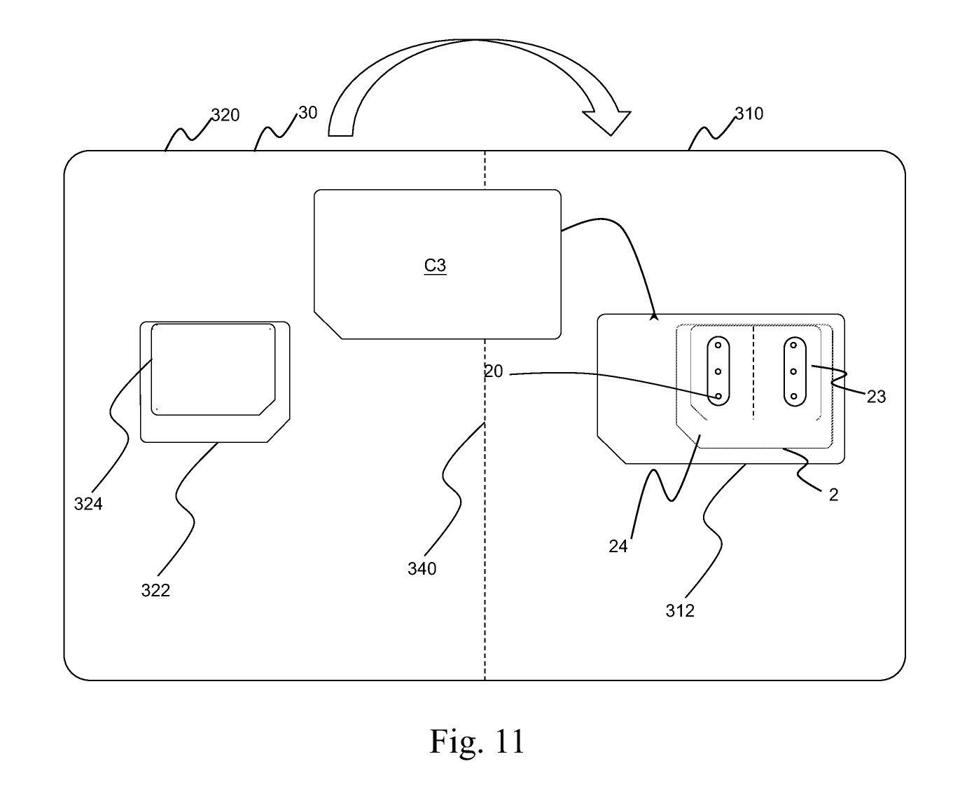

For using different type of SIM card, a different procedure is applied. Please refer to FIG. 11 to FIG. 14. If the auxiliary mounting structure 3 is used to mount the advanced smart card 2 onto the mini-SIM card C3, (please see FIG. 11), the whole procedure is described below. First, remove the small board and the separating release paper. Fold the auxiliary mounting structure 3 along the folding line 340. Push the advanced smart card 2 from the back of the fourth removed region 324 so that the advanced smart card 2 is attached to the plastic film 330 in the second removed region 314 with one side having the release paper facing the reader. Next, remove the inner portion 23 and outer portion 24 of the release paper. Finally, put the mini-SIM card C3 into the first removed region 312 with the contacts of the mini-SIM card C3 facing the advanced smart card 2. Since the advanced smart card 2 is stuck by the glue, the advanced smart card 2 is mounted onto the mini-SIM card C3.

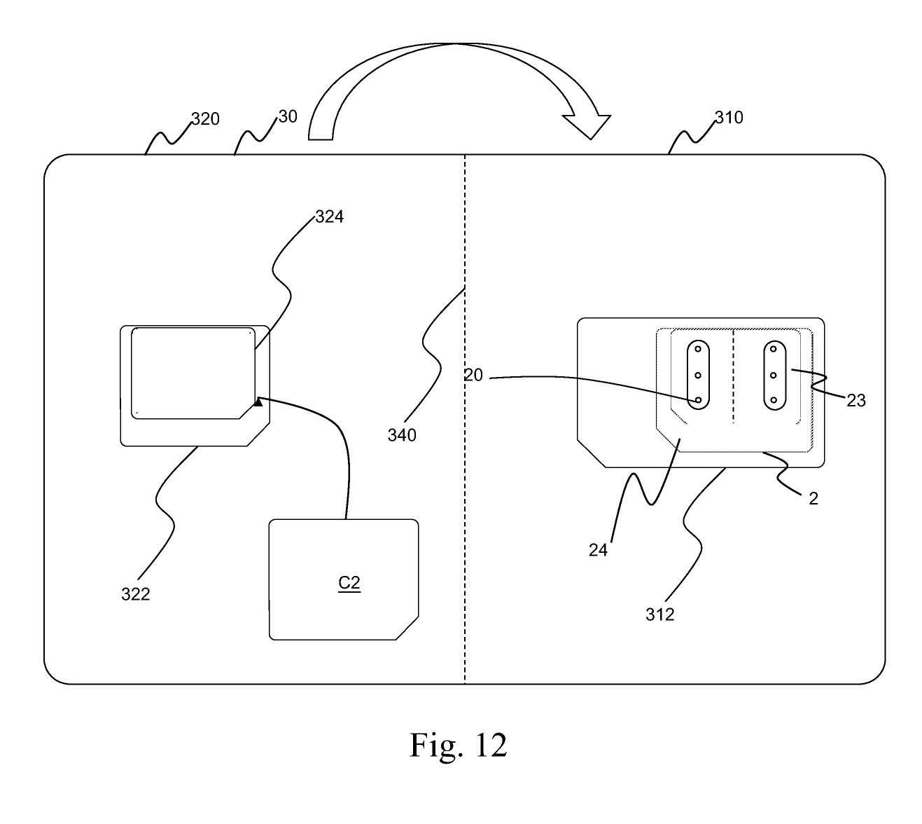

Please see FIG. 12. If the auxiliary mounting structure 3 is used to mount the advanced smart card 2 onto the micro-SIM card C2, the small board and the separating release paper should be removed in the first step. Fold the auxiliary mounting structure 3 along the folding line 340. Push the advanced smart card 2 from the back of the fourth removed region 324 so that the advanced smart card 2 is attached to the plastic film 330 in the second removed region 314 with one side having the release paper facing the reader. Next, remove the inner portion 23 and outer portion 24 of the release paper. Then, put the micro-SIM card C2 into the third removed region 322 and temporarily fix the micro-SIM card C2 by the glue on the platform formed by the board of the auxiliary mounting structure 3. The contacts of the micro-SIM card C2 face the reader. Finally, fold the auxiliary mounting structure 3 by 180 degrees along the folding line 340 again. Combine the micro-SIM card C2 and advanced smart card 2 by the glue on the advanced smart card 2. In practice, it is workable to align the micro-SIM card C2 with the second removed region 314, directly glued with the advanced smart card 2. The advanced smart card 2 is thus mounted onto the micro-SIM card C2.

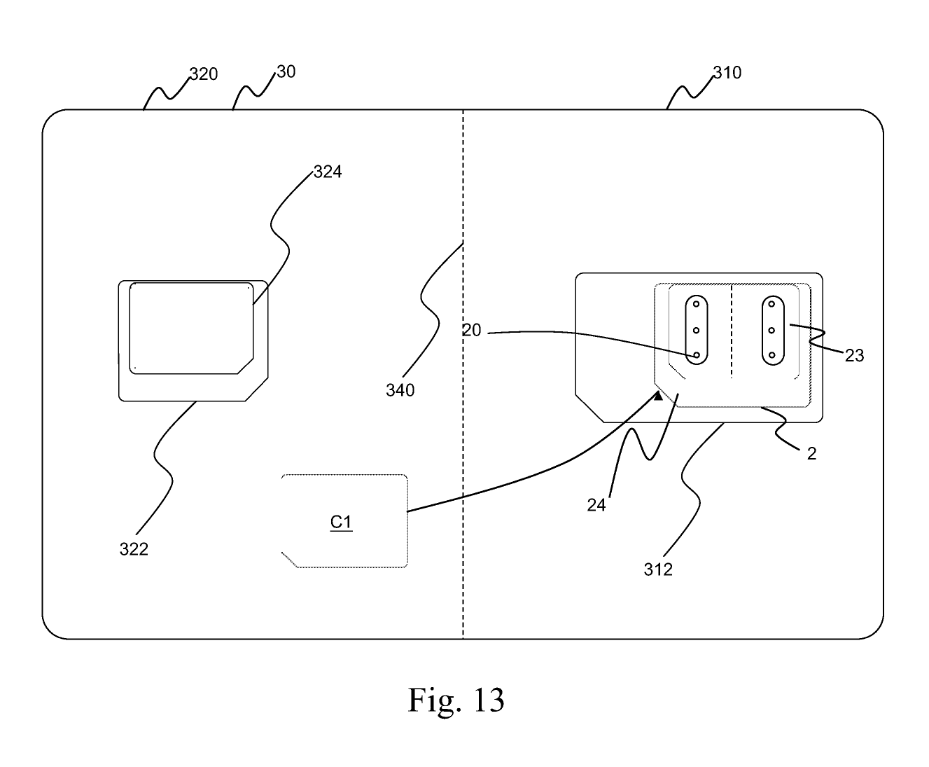

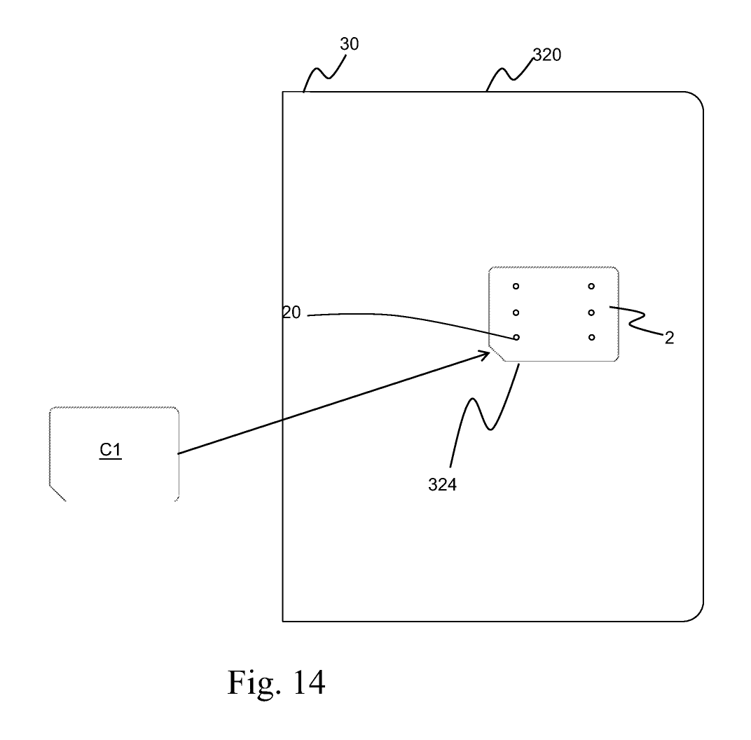

If the auxiliary mounting structure 3 is used to mount the advanced smart card 2 onto a nano-SIM card C1, please see the illustration shown by FIG. 13. Similarly, remove the small board and the separating release paper first. Attach the advanced smart card 2 to the plastic film 330 in the second removed region 314 with one side having the release paper facing the reader. Next, remove the inner portion 23 of the release paper. Finally, place the nano-SIM card C1 to align with the location where the inner portion 23 originally was, with the contacts of the nano-SIM card C1 facing the advanced smart card 2. Press the nano-SIM card C1 tightly. Remove the advanced smart card 2 from the plastic film 330. The nano-SIM card C1 and the advanced smart card 2 are combined the glue on the advanced smart card 2. Thus, the advanced smart card 2 can be mounted onto the nano-SIM card C1. If it is concerned that the nano-SIM card C1 may not align with the location where the inner portion 23 originally was, please refer to FIG. 14. Flip the auxiliary mounting structure 3 to the back. Place it with one side of the fourth removed region 324 facing the reader. Fold the auxiliary mounting structure 3 180 degrees along the folding line 340. Place the nano-SIM card C1 from the back of the fourth removed region 324.

For both embodiments described above, preferably, the board can be made of cardboard, plastic, carbon fiber, or metal. If it is made of plastic, nylon is a good material to use. The board can be formed by injection. If it is made of metal, aluminum or aluminum alloy can be a choice. For all kinds of materials mentioned above, the method to form the board can be stamping or cutting with some/all cut portions removed.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. An auxiliary mounting structure, formed by a board, for mounting an advanced smart card which has a contact side with a plurality of smart card contacts, onto a Subscriber Identity Module (SIM) card, comprising:
a first accommodating portion, comprising:
a first removed region, having a shape substantially equal to that of a first type SIM card; and
a second removed region, formed below the first removed region and penetrating the board, having a shape substantially equal to that of a second type SIM card;
a second accommodating portion, comprising:
a third removed region, having a shape substantially equal to that of the second type SIM card; and
a fourth removed region, formed below the third removed region and penetrating the board, having a shape substantially equal to that of a third type SIM card;
a folding line, formed between the first accommodating portion and the second accommodating portion, for dividing the auxiliary mounting structure into equal sizes and facilitating folding of the auxiliary mounting structure; and
a plastic film, glued on a gluing side, attached underneath the first removed region;
wherein a shape of the advanced smart card is substantially the same as that of the second type SIM card; locations and shapes of the second removed region are mirroring of that of the third removed region with respect to the folding line.

2. The auxiliary mounting structure according to claim 1, wherein the board is made of cardboard, plastic, carbon fiber, or metal.

3. The auxiliary mounting structure according to claim 1, wherein the first type SIM card is a mini-SIM card (2FF).

4. The auxiliary mounting structure according to claim 1, wherein the second type SIM card is a micro-SIM card (3FF).

5. The auxiliary mounting structure according to claim 1, wherein the third type SIM card is a nano-SIM card (4FF).

6. The auxiliary mounting structure according to claim 1, wherein the plastic film is made by Poly Ethylene (PE), Poly Vinyl Chloride (PVC) or Poly Ethylene Terephthalate (PET).

7. The auxiliary mounting structure according to claim 1, wherein the advanced smart card has a flexible printed circuit board with the smart card contacts on the contact side and an integrated circuit.

8. The auxiliary mounting structure according to claim 1, wherein the advanced smart card has a layer of glue around the smart card contacts and covered by a release paper.
